(19) United States
(12) Patent Application Publication
(10) Pub. No.: US 2016/0296995 A1
(43) Pub. Date: Oct. 13, 2016

(54) METHOD AND APPARATUS FOR FORGING A HARD DISK DRIVE BASE PLATE WITH AN EXTENDED HEIGHT

(71) Applicant: CHEUNG WOH TECHNOLOGIES LTD., Singapore (SG)

(72) Inventors: Kung Ying LAW, Singapore (SG); Yut Chai LOH, Penang (MY)

(21) Appl. No.: 14/801,788

(22) Filed: Jul. 16, 2015

(30) Foreign Application Priority Data
Apr. 13, 2015 (CN) 201510172513.5

(51) Int. Cl. B21J 1/06; B21J 5/00; B21K 27/00; G11B 33/14; B21K 21/04

(52) U.S. Cl. CPC B21J 1/06; G11B 33/1446; B21K 21/04; B21K 27/00; B21J 5/008

(57) ABSTRACT

A method and apparatus for forging a hard disk drive base plate with an extended height is described. The method may include advancing an initial hard disk drive base plate to a first forging stage of a sequence of progressive forging stages for forming the hard disk drive base plate, wherein a sequence of forgings are performed over the sequence of progressive forging stages to progressively form parts for a hard disk drive base plate. The method may also include performing a first forging operation on the initial hard disk drive base plate, preheating the hard disk drive base plate, and then performing a second forging operation on the preheated hard disk drive base plate.

### FIELD

Embodiments of the present invention relate generally to the field of manufacturing metal parts and more specifically, a manufacturing process for forming a base plate for a hard disk drive.

### BACKGROUND

The housing of a hard disk drive for use in computer systems typically includes a cover and a base plate attached with screws. A base plate supports the hard disk drive assembly (e.g., spindle, motor, and actuator).

One conventional base plate manufacturing process includes press working a sheet of metal with side frames mounted on opposing sides. In this process, a base plate is press worked to form a concave portion with a few holes for motor mounting. Two side frames are press worked from sheet metal and are fixedly mounted on the opposite sides of the base plate to create the hard disk drive base plate with walls of a desired height. The press-worked and assembled hard disk drive base plate can be associated with several problems. For example, the hard disk drive base plate often suffers from porosity and cavity problems associated with die casting (e.g., bubbles or air pockets in the cast metal base plate), resulting in a lack of predictability of resonance. Furthermore, fixing the two side frames to the base plate is an additional assembly step that typically increases the time and cost of manufacturing, and may result in the introduction of oil or other residue used during the cold working operations that must be removed by yet additional operations.

Another base plate manufacturing processing includes forging the hard disk drive base plate from a single piece of metal. One exemplary process for forging a hard disk drive base plate is described in U.S. patent application Ser. No. 13/457,304, entitled Method and Apparatus for Progressively Forging a Hard Disk Drive Base Plate, filed Apr. 26, 2012. Such forged hard disk drive base plates solve the problems associated with die-casting methods by eliminating the bubbles or air pockets found in die cast and assembled hard disk drive base plates. Hard disk drive base plate forgings are, however, often limited to a maximum side walls achievable by the forging process. More specifically, the wall height of forged hard disk drive base plates cannot exceed 15 millimeters due to work-hardening.

A wall height of 15 millimeters is generally not a sufficient side wall height for a finished hard disk drive based plate. Thus, the height of the hard disk drive base plate may be extended by joining a side wall extension to the forged hard disk drive base plate. One exemplary process for extending the height of the side walls of a forged hard disk drive base plate is described in U.S. patent application Ser. No. 14/555,483, entitled Method and Apparatus for Forming a Hard Disk Drive Base Plate with an Extended Height, filed Nov. 26, 2014. The hard disk drive base plate with an extended height may also be subject to problems that make the resulting extended height hard disk drive base plate less than optimal. For example, the material used to extend the height of the hard disk drive base plate walls may suffer from the same drawbacks of the press worked metal discussed above. Furthermore, gas may flow or leak into or out of the finished hard disk drive base plate through the joints where the forged hard disk drive base plate and the height extensions are joined. The leaking or introduction of gasses to the interior components of a finished hard disk drive base plate can result in harmful and/or unintended effects to the components and operation of the finished hard disk drive.

### BRIEF DESCRIPTION OF THE DRAWINGS

Embodiments of the present invention are illustrated by way of example, and not limitation, in the figures of the accompanying drawings in which:

FIG. 1 illustrates one embodiment of a system for forging a hard disk drive base plate with an extended height.

FIG. 2 illustrates another embodiment of a system for forging a hard disk drive base plate with an extended height.

FIG. 3 illustrates a block diagram of a method of forging a hard disk drive base plate with an extended height.

### DETAILED DESCRIPTION

A method using transfer die stamping to forge and form a hard disk drive base plate with an extended height is described. For one embodiment, an initial blank base plate is advanced through a plurality of stations of a transfer die assembly. Parts are forged on the initial blank base plate to form a hard disk drive base plate. The forging comprises forming various parts of the hard disk drive base plate, such as a motor hub, a voice coil motor relief surface, an actuator pivot bearing post, as well as other parts forged from the initial blank to form the final hard disk drive base plate form. The forging occurs over a sequence of stages, where each stage in the sequence involves forming, either partially or fully, various features of the hard disk drive base plate. For one embodiment, pre-heating of the partially formed hard disk drive base plate is performed in between one or more forging stages of the sequence of stages. The pre-heating is performed to bring the partially formed hard disk drive base plate up to a predetermined temperature for a minimum duration of time. After the partially formed hard disk drive base plate has been held at the predetermined temperature for the minimum duration of time, it is rapidly transferred to a next forging station to fully or partially form new or existing parts of the hard disk drive base plate. For embodiments, the pre-heating may occur once, before specific forging stages in the sequence of stages, or before every sequential forging stage between the first pre-heating and the final forging stage in the sequence of stages.

By pre-heating the partially formed hard disk drive base plate between stages and prior to performing one or more forging operations, the height of the side walls of the fully formed hard disk drive base plate can exceed a height of 15 millimeters. For one embodiment, the height of the side walls exceeds 30 millimeters and may extend to 50 millimeters. By forging the hard disk drive base plate from a homogeneous material, with a sidewall height of greater than 15 millimeters and up to 50 millimeters, porosity and cavity imperfections in the formed hard disk drive base plate are minimized or avoided, leading to a greater predictability of resonance of the formed hard disk drive base plate. Furthermore, because there are no joints, welds, or other parts joined to the hard disk drive base plate to raise a height of the sidewalls, the hard disk drive base plate will not be subject to gas leakage and flow problems into and out of a finished hard disk drive. A base plate pre-heated and forged over a series of stages, as discussed herein, results in a working hardening of the formed base plate, therefore improving the rigidity and tensile strength of the forged base plate over die cast and conventional press working base plates. For example, the forged hard disk drive base plate, as discussed herein, will have reduced non-homogeneous stress distortion and a more compact grain structure from the working hardening effect.

The embodiments for forming a hard disk drive base plate from a sequence of progressive forging operations, including pre-heating the partially formed hard disk drive base plate to a predetermined temperature for a minimum duration of time between one or more forging stages, are discussed herein with respect to forming a hard disk drive base plate. The forging methods discussed herein may also be used for forming other types of metal parts.

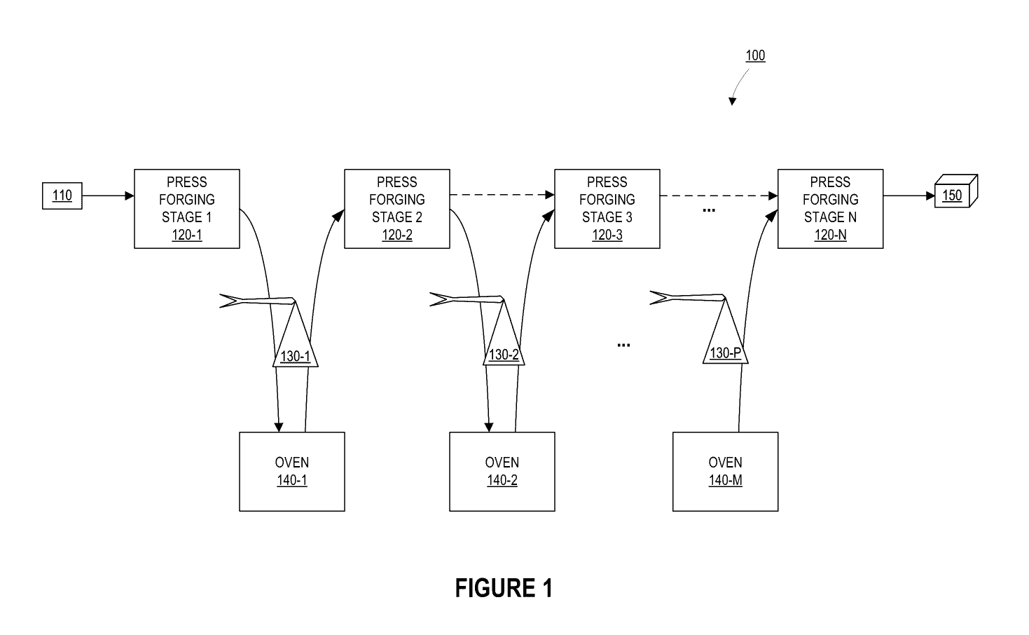

FIG. 1 illustrates one embodiment of a system 100 for forging a hard disk drive base plate with an extended height. For one embodiment, an extruded sheet of metal 110 is progressively formed in a series of transfer dies over a sequence of progressive forging stages (e.g., stages 120-1 through 120-N) to form a hard disk drive base plate 150. The press plates of the transfer dies that perform forging operations are coated in a titanium nitride (“TiN”) coating, or made from high speed steel or carbide tool steel, to increase the hardness of the press plates, and increase the tool life of the press plates, as well as to improve the efficiency of the forging. For one embodiment, additional press working operations are performed in additional stages by additional machines (not shown) to further form the hard disk drive base plate, including trimming, piercing, stamping, coining, or other suitable processes.

For one embodiment, the metal used in the sequence of forging stages for forming a hard disk drive base plate is an aluminum alloy, such as aluminum 6061, aluminum 5052, or aluminum 110. For alternative embodiments, other suitable materials such as, for example, cold rolled or low carbon steel may also be used. For one embodiment, the metal used to form the hard disk drive base plate may be chosen based on various factors—for example, design requirements, desired material properties, reduced contamination (i.e., silicon, copper, zinc, etc. contamination) of the raw material for the hard disk drive base plate, and reduced natural magnetism of the hard disk drive base plate. For one embodiment, the aluminum alloy in the form of the extruded sheet 110 is initially used to prepare a blank for stamping and forming of a hard disk drive base plate. The thickness of the extruded sheet 110 may range from about 1 mm to about 6 mm. Selection of material thickness and an extruded sheet's profile may vary depending on a particular product design.

A progressive die assembly utilized to form hard disk drive base plate 150 with a sequence of progressive forging operations may include multiple stations at stages 120-1 through 120-N. The initial hard disk drive base plate (e.g., extruded sheet 110) is advanced from station to station to complete each of the plurality of progressive forgings. Each station may perform forgings, as well as other machining operations, from more than one stage. The specific forging operations form, either partially or fully, parts on the hard disk drive base plate as it is advanced through the sequence of stages. The sequence of progressive forgings form, either partially or fully, specific parts on the hard disk drive base plate at specific stages in order to manage the movement of material caused by the forging operations, and to ensure a uniform thickness of the resulting fully formed hard disk drive base plate. Furthermore, the order of forging operations and formation of different parts ensures that the intricate details of the hard disk drive base plate are properly formed.

Initial hard disk drive base plate is advanced into press forging stage 1 120-1 to perform a first progressive forging operation in the formation of the hard disk drive. In stage 1, a first forging is performed that can result in the material thickness in the middle of initial hard disk drive base plate to be moved to the sides and a motor hub portion of initial hard disk drive base plate.

For one embodiment, after the first progressive forging operation has been performed, a robotic arm 130-1, or other mechanical pick-and-place means, unloads the partially formed hard disk drive base plate from press forging stage 1 120-1 and transfers the partially formed hard disk drive base plate to oven 140-1. The oven 140-1 pre-heats the partially formed hard disk drive base plate before transfer back to press forging stage 2 120-2. For one embodiment, the partially formed hard disk drive base plate is heated to a predetermined temperature, such as 300° C. Furthermore, once the temperature reaches the predetermined temperature, the oven 140-1 holds the hard disk drive at that temperature for a minimum duration of time, such as 30-45 minutes.

After at least the minimum time has elapsed, robotic arm 130-1 picks the pre-heated partially formed hard disk drive base plate from oven 140-1 and transfers it to press forging stage 2 120-2 where additional forging operations are performed to partially or fully form parts on the hard disk drive base plate. Because the partially formed hard disk drive base plate was pre-heated before the forging operations performed at press forging stage 2 120-2, the height of the side walls formed in the partially formed hard disk drive base plate can be raised higher than 15 millimeters.

The robotic arm 130-1 or other mechanical means performs the transfer because transfer to and from the oven to and from the various press forging stages (e.g., stages 120-2, 120-3, through 120-N) is a time sensitive operation. That is, to prevent heat loss during the transfer to and from the oven to the various press forging stages, the robotic arms and/or other mechanical means are employed so that the transfer may be achieved in under a maximum duration of transfer time, such as not more than 8 seconds. The next forging operations are then performed at the next press of press forging stage 3 120-3. These forging operations can include partially or fully forming existing or additional parts of the hard disk drive base plate, such as partially or fully forming a motor hub, a voice coil relief surface, an actuator pivot bearing post, a disk relief surface, an actuator relief surface, an actuator sitting surface, a motor sitting surface, a ramp pad surface, etc.

Depending on design requirements of the formed hard disk drive base plate 150, additional pre-heatings may be performed in ovens 140-2 through 140-M before the forging operations performed at corresponding stages 120-3 through 120-N. For example, the forging performed at stage 2 120-2 after the pre-heating may result in a partially formed hard disk drive base plate with side walls greater than 15 millimeters. To further extend the side walls to a desired height, such as a height in the range of 30 millimeters to 50 millimeters, the additional pre-heatings are performed in each of ovens 140-2 through 140-M prior to each of the remaining press forging stages 120-3 through 120-N. For other embodiments, however, pre-heating of a partially formed hard disk drive base plate need not occur prior to each forging stage, and instead may occur for a number of consecutive stages until a desired sidewall height is obtained (e.g., pre-heating performed prior to three consecutive stations our of six total stations). For yet other embodiments, pre-heating can occur prior to specific and non-consecutive stages depending on the particular forging operations being performed.

For one embodiment, the forging press of stage 2 120-2 may be a larger tonnage press than the presses of the other stages (e.g., stages 120-1 and 120-3 through 120-N). When the forging press of stage 2 120-2 is of a larger tonnage, the forging operation performed at stage 2 is able to form higher side walls, such as side walls with a height between 30 and 50 millimeters from the single forging stage. Depending on design requirements of the ultimate formed hard disk drive base plate 150, the desired height of the hard disk drive base plate 150 can be fully raised at the press of stage 2 120-2. For this embodiment, robotic arms 130-2 through 130-P would transfer the partially formed hard disk drive base plate between stages, without transfer to ovens 140-2 through 140-M for additional pre-heatings before later forging stages. This embodiment is illustrated utilizing the dashed lines between stages 120-2 through 120-N.

After the final press forging stage N 120-N, the hard disk drive base plate 150 has been formed. Additional operations (not shown) may be performed to finish the hard disk drive base plate's manufacture. For example, trimming operations may be performed to trim overflow material that could have formed during the progressive forging operations. As another example, certain parts, such as a motor hub hole, an oblong hole on actuator relief surface, and a flex bracket rectangle hole may be pierced and/or drilled, rather than forged. As other examples of post-forging operations, parts may be machined and the formed hard disk drive base plate washed and/or made to undergo various coatings or surface treatments. For one embodiment, a surface finishing or coating, such as Electroless Nickel Plating, may be applied after the surface treatment and before proceeding to a next assembly process involving the formed based plate, such as mounting of a motor assembly, actuator arm, and VCM assembly, on the formed hard disk drive base plate 150.

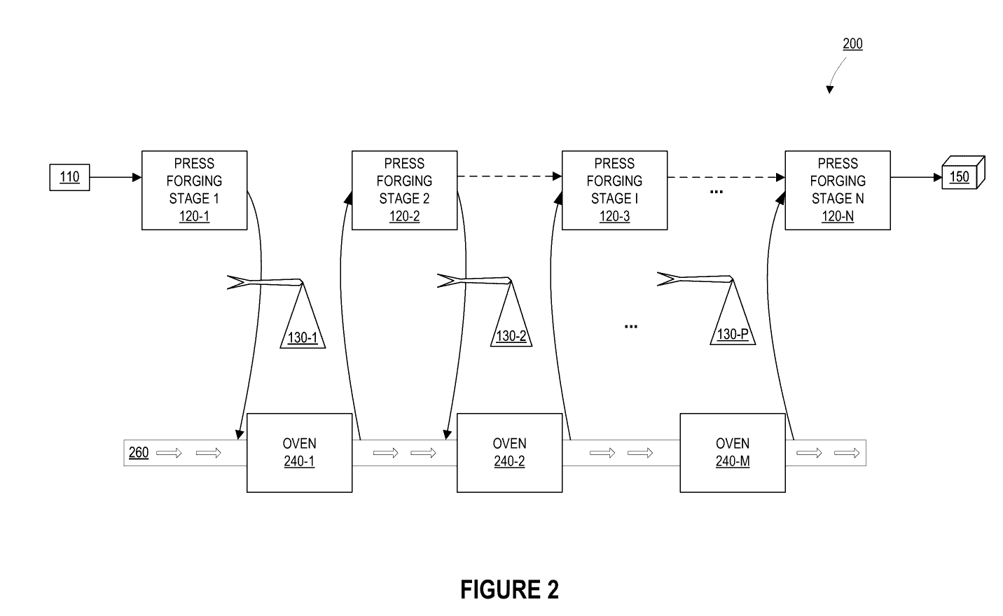

FIG. 2 illustrates another embodiment of a system 200 for forging a hard disk drive base plate with an extended height. The system 200 illustrated in FIG. 2 is similar to FIG. 1 in that the initial blank (e.g., extruded sheet 110) is transferred to and from a series of sequential press forging stages 120-1, 120-2, 120-3 through 120-N by robotic arms 130-1, 130-2 through 130-P. Furthermore, pre-heating to a predetermined temperature for a minimum duration of time can be performed before one or more of the stages 120-2 through 120N in the plurality of ovens, as discussed above.

For system 200, however, a conveyor system 260 is deployed for one or more conveyor ovens 240-1 and 240-2 through 240-M. For one embodiment, although not illustrated, the conveyor system 260 may comprise two or more conveyors, such as different conveyors for each oven. The conveyor system 260 controls the time each partially formed hard disk drive base plate is within an oven, such as oven 240-1, based on the speed that the conveyor is moving. That is, robotic arm 130-1 can pick a partially formed hard disk drive base plate from press forging stage 1 120-1 and place it on conveyor system 260. Conveyor system 260 moves the base plate through conveyor oven 240-1 at a certain speed to ensure that the temperature of the partially formed hard disk drive base plate reaches the predetermined temperature and is held at that temperature for the minimum duration of time. As the pre-heated and partially formed hard disk drive base plate emerges from the conveyor oven 240-1, robotic arm 130-1 rapidly transfers the hard disk drive base plate to the next press forging stage (e.g., press forging stage 2 120-2).

The conveyor system 260 and one or more conveyor ovens may be utilized consistent with the discussion above in FIG. 1 to preheat the hard disk drive while it travels along a conveyor inside the oven(s). For any of the conveyor embodiments, the conveyor based system enables the continuous operation of the presses of forging stages 120-1 through 120-N. Furthermore, the conveyor based system enables work in progress to be accumulated between forging stages to further assist the continuous operation of the presses of stages 120-1 through 120-N.

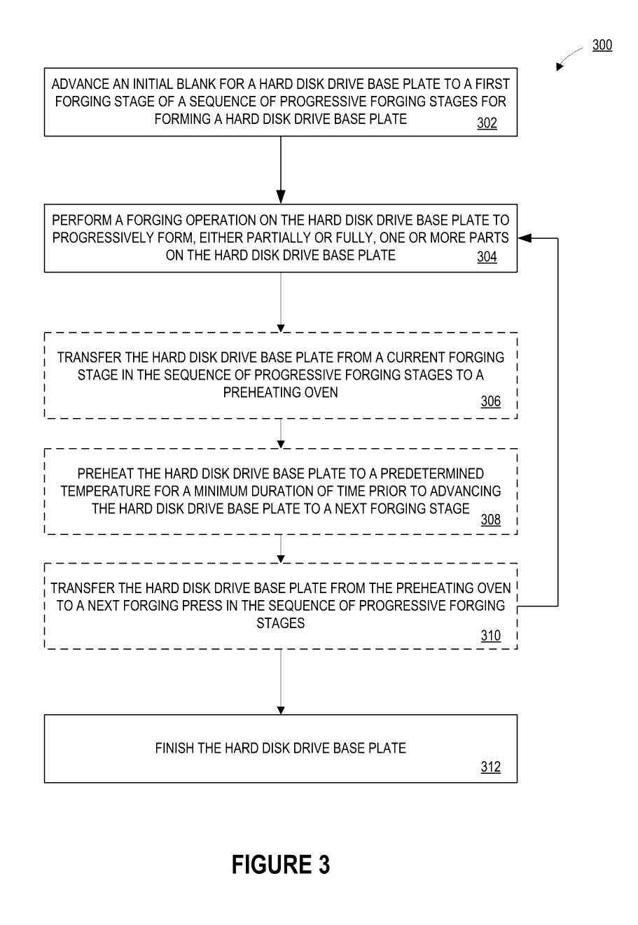

FIG. 3 illustrates a block diagram of a method 300 of forging a hard disk drive base plate with an extended height. The progressive die assembly used in the method illustrated by FIG. 3 may include multiple stations with a hard disk drive base plate advanced from station to station, and preheated in between one or more of the multiple stages. The method includes performing a sequence of progressive forgings using the transfer die assembly.

The method begins by advancing an initial blank for a hard disk drive base plate to a first forging stage of a sequence of progressive forging stages for forming a hard disk drive base plate (block 302). A forging operation is then performed on the hard disk drive base plate to progressively form, either partially or fully, one or more parts on the hard disk drive base plate (block 304).

After a forging operation, the hard disk drive base plate may be transferred from a current forging stage in the sequence of progressive forging stages to a preheating oven (block 306). The transfer may be performed with a robotic arm capable of picking the hard disk drive base plate from a forging press and transferring it to another forging press or pre-heating oven, as discussed herein. The transfer may also be performed with other mechanical means capable of picking and placing the hard disk drive base plate, as discussed herein.

The hard disk drive base plate is preheated to a predetermined temperature for a minimum duration of time prior to advancing the hard disk drive base plate to a next forging stage (block 308). For one embodiment, the hard disk drive base plate is pre-heated in an oven to a temperature of 300° C. and held at that temperature for a minimum of 30-45 minutes. The preheated hard disk drive base plate is then transferred from the preheating oven to a next forging press in the sequence of progressive forging stages (block 310). For one embodiment, the transfer is back to block 304 for performing the forging operations of a current stage in the sequence of progressive forging stages.

Blocks 306 through 310 are illustrated by way of dashed lines because preheating a partially formed hard disk drive base plate (1) may only be performed once (e.g., between stages 1 and 2); (2) may be performed a number of consecutive times (e.g., between each stage after stage 1); (3) may be performed over consecutive stages of a subset of all forging stages; (4) may be performed before specific stages (e.g., before stages 2 and 4, before stages 2-4, and 6, etc.); or (5) may be performed at various other times. When pre-heating does not occur between forging stages, the forged hard disk drive base plate is transferred from a current forging stage to a next forging stage in the sequence of progressive forging stages.

After all of the stages of the sequence of progressive forging stages have been completed, the formed hard disk base plate is finished (block 312). As discussed above, finishing the hard disk drive base plate can involve one or more of trimming excess material from the hard disk drive base plate; punching, piercing, or drilling holes in the hard disk drive base plate; performing one or more washing processes on the hard disk drive base plate; performing a coating process on the hard disk drive base plate, as well as other finishing operations.

Although not illustrated, the finished hard disk drive base plate—which was formed over a sequence of progressive forging operations—can then be transferred to another stage of the hard disk drive assembly process (e.g., installing hard disk drive parts on the finished hard disk drive base plate).

In the foregoing specification, the invention has been described in reference to specific exemplary embodiments thereof. It will, however, be evident that various modifications and changes may be made thereto without departing from the described spirit and scope of the invention. The specification and drawings are, accordingly, to be regarded as illustrative rather than a restrictive sense.

What is claimed is:

1. A method for forging a hard disk drive base plate, comprising:
advancing an initial hard disk drive base plate to a first forging stage of a sequence of progressive forging stages for forming a hard disk drive base plate, wherein a sequence of forgings are performed on the initial hard disk drive base plate over the sequence of progressive forging stages to progressively form parts for the hard disk drive base plate;
performing a first forging operation on the initial hard disk drive base plate to progressively form, partially or fully, one or more parts on the hard disk drive base plate;
preheating the hard disk drive base plate prior to advancing the hard disk drive base plate to a second forging stage of the sequence of progressive forging stages for forming the hard disk drive base plate; and
performing a second forging operation on the preheated hard disk drive base plate to progressively form, partially or fully, one or more parts on the preheated hard disk drive base plate and raise a height of side walls of the preheated hard disk drive base plate.

2. The method of claim 1, wherein preheating the hard disk drive base plate prior to advancing the hard disk drive base plate to the second forging stage comprises:
preheating the hard disk drive base plate to a predetermined temperature; and
holding the hard disk drive base plate at the predetermined temperature for a minimum duration of time.

3. The method of claim 2, wherein the predetermined temperature is at least 300° C., and wherein the minimum duration of time is in a range of 30 minutes to 45 minutes.

4. The method of claim 2, wherein the hard disk drive base plate is preheated between the first forging stage and the second forging stage of the sequence of progressive forging stages without being preheated before remaining forging stages of the sequence of progressive forging stages.

5. The method of claim 4, wherein a tonnage of a forging press of the second forging stage is greater than a tonnage of forging presses of remaining forging stages, and wherein the height of side walls of the preheated hard disk drive base plate are raised to a height between 30 millimeters and 50 millimeters from the second forging operation.

6. The method of claim 2, wherein the hard disk drive base plate is preheated between the first forging stage and the second forging stage of the sequence of progressive forging stages and preheated before each remaining forging stage in the sequence of progressive forging stages.

7. The method of claim 6, wherein the height of side walls of the preheated hard disk drive base plate are raised to a height between 30 millimeters and 50 millimeters over the sequence of progressive forging stages.

8. The method of claim 2, wherein the preheating is performing in an oven, further comprising:
transferring the preheated hard disk drive base plate from the oven to the second forging stage after the minimum duration of time for the preheating has elapsed, wherein the transfer is performed in under a maximum duration of transfer time.

9. The method of claim 8, wherein the transfer of the transfer of the preheated hard disk drive base plate from the oven to the second forging stage is performed by a robotic arm.

10. The method of claim 8, wherein the oven is a conveyor oven, and wherein the hard disk drive base plate is preheated while traveling along a conveyor inside the oven.

11. The method of claim 1, wherein the height of side walls of the preheated hard disk drive base plate are raised greater than 15 millimeters from the second forging operation.

12. The method of claim 1, wherein the hard disk drive base plate is formed from an aluminum alloy.

13. A system for forging a hard disk drive base plate, comprising:
a transfer die assembly to advance an initial hard disk drive base plate through forging stages of a sequence of progressive forging stages for forming a hard disk drive base plate, wherein a sequence of forgings are performed on the initial hard disk drive base plate over the sequence of progressive forging stages to progressively form parts for the hard disk drive base plate;
a first forging stage in the sequence of progressive forging stages to perform a first forging operation on the initial hard disk drive base plate to progressively form, partially or fully, one or more parts on the hard disk drive base plate;
an oven to preheat the hard disk drive base plate to a predetermined temperature for a minimum duration of time prior to advancing the hard disk drive base plate to a second forging stage of the sequence of progressive forging stages for forming the hard disk drive base plate; and
a second forging stage in the sequence of progressive forging stages to perform a second forging operation on the preheated hard disk drive base plate to progressively form, partially or fully, one or more parts on the preheated hard disk drive base plate and raise a height of side walls of the preheated hard disk drive base plate.

14. The system of claim 13, wherein the hard disk drive base plate is preheated to a predetermined temperature and held in the oven at the predetermined temperature for a minimum duration of time prior to advancing the hard disk drive base plate to the second forging stage.

15. The system of claim 14, wherein the predetermined temperature is at least 300° C., and wherein the minimum duration of time is in a range of 30 minutes to 45 minutes.

16. The system of claim 14, wherein the hard disk drive base plate is preheated between the first forging stage and the second forging stage of the sequence of progressive forging stages without being preheated before remaining forging stages of the sequence of progressive forging stages.

17. The system of claim 16, wherein a tonnage of a forging press of the second forging stage is greater than a tonnage of forging presses of remaining forging stages, and wherein the height of side walls of the preheated hard disk drive base plate are raised to a height between 30 millimeters and 50 millimeters from the second forging operation.

18. The system of claim 14, wherein the hard disk drive base plate is preheated between the first forging stage and the second forging stage of the sequence of progressive forging stages and preheated in one or more ovens before each remaining forging stage in the sequence of progressive forging stages.

19. The system of claim 18, wherein the height of side walls of the preheated hard disk drive base plate are raised to a height between 30 millimeters and 50 millimeters over the sequence of progressive forging stages.

20. The system of claim 14, further comprising:
a robotic arm to transfer the preheated hard disk drive base plate from the oven to the second forging stage after the minimum duration of time for the preheating has elapsed, wherein the transfer is performed by the robotic arm in under a maximum duration of transfer time.

21. The system of claim 20, wherein the oven is a conveyor oven, and wherein the hard disk drive base plate is preheated while traveling along a conveyor inside the oven.

22. The system of claim 14, wherein the height of side walls of the preheated hard disk drive base plate are raised greater than 15 millimeters from the second forging operation.

23. The system of claim 14, wherein the hard disk drive base plate is formed from an aluminum alloy.

24. The system of claim 14, wherein press plates of the forging stages of the transfer die assembly that perform the forging operations are coated with titanium nitride.

25. The system of claim 14, wherein the hard disk drive base plate is formed from an aluminum alloy.
